(19) United States
(12) Patent Application Publication
(10) Pub. No.: US 2007/0283385 A1
(43) Pub. Date: Dec. 6, 2007

(54) Methods and apparatus to provide media content created for a specific individual via IPTV

(76) Inventors: Chaoxin Charles Qiu, Austin, TX (US); Diana Maria Cantu, Austin, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/445,121

(22) Filed: Jun. 1, 2006

(51) Int. Cl. G06F 13/00; H04N 5/445; G07B 15/00; G06F 3/00; H04N 7/10

(52) U.S. Cl. 725/34; 235/35

(57) ABSTRACT

Methods and apparatus to provide to provide media content created for a specific individual on Internet Protocol Television (IPTV) are disclosed. An example set top box includes an interface coupled to a television to display an identification of a channel on the television. A user control is in communication with the interface. The user control allows a user to select the channel to activate a secure Internet Protocol television transmission. The interface accepts the media content created for a specific individual via the secure Internet Protocol television transmission for display on the television.

### FIELD OF THE DISCLOSURE

This disclosure relates generally to exchange of media content, and, more particularly, to methods and apparatus to provide media content created for a specific individual on Internet Protocol Television (IPTV).

### BACKGROUND

The Internet Protocol (IP) Television (IPTV) refers to a system in which a digital television service is delivered to subscribers using an Internet Protocol over a broadband connection. The service typically may be supplied by a broadband operator and may also include Video on Demand (VOD) and Internet services such as world wide web access and Voice over Internet Protocol (VoIP) telephony using the same infrastructure.

An IPTV system uses two-way communication and, therefore, may typically use broadband technology such as xDSL over the local loop. Television programming content may be acquired and stored for delivery to subscribers using, for example, a Digital Subscriber Line Access Multiplexer (DSLAM). Network architecture for IPTV differs, therefore, from conventional cable television system architecture.

IPTV allows two-way capability unavailable with traditional broadcast TV distribution technologies, as well as point-to-point distribution. These two features allow each subscriber or user to view selected content at their convenience. IP distribution enables stream control such as, for example, pause, fast forward and rewind functions over the broadcast. Traditional television distribution technologies such as terrestrial, satellite, and cable television do not use real packet switching transport on an access network. VOD in the United States may typically be delivered over cable TV using the Digital Video Broadcasting (DVB) protocol on selected frequency bands which is not an IPTV service.

Currently, content offered to TV viewers is typically controlled by studios and service providers with feeds of so-called “main stream” content. TV users can view other customized or individualized media content only with the proper hardware connected to their televisions. Such media content includes individually generated video clips using camcorders, digital photos using (digital) cameras, DVD and video type and content captured and replayed using DVR devices.

In TV broadcast networks, there is no natural way for uni-casting-style content flow through the network in which a subscriber creates a piece of content and offers it to another subscriber. In the Internet domain, the uni-casting style of content flow is becoming more popular using email and web technology. For example, a consumer can take pictures, load them to a personal computer, and send them out to other individuals. Additionally, web enabled cell phones with a built in digital camera can take a picture and send the picture to other individuals via the Internet. However, these content sharing methods still require the recipients to have access to a personal computer and/or a web enabled cell phone.

### BRIEF DESCRIPTION OF DRAWINGS

FIG. 1 is an example broadband based environment to deliver services such as IP television to IP television subscribers.

FIG. 2 is a block diagram of the contents of an example mediation database in the environment of FIG. 1.

FIG. 3 is a block diagram of an example local IPTV hub in the environment of FIG. 1.

FIG. 4 is a block diagram of an example content server to provide personalized data for the IP television to IP television subscribers in FIG. 1.

FIG. 5 is a flow diagram representative of a process that may be executed by the example content server in FIG. 4 to send content prepared by an individual to an IPTV receiver.

FIG. 6 is a block diagram of an example computing device that may execute the process represented by FIG. 5 to implement the example system in FIG. 1 to display media content prepared by an individual.

### DETAILED DESCRIPTION

In general, example methods and apparatus to provide media content prepared by individuals on IPTV is disclosed. An example television set top box to view media content created for a specific individual has an interface coupled to a television to display an identification of a channel on the television. A user control is in communication with the interface. The user control allows a user to select the channel to activate a secure Internet Protocol television transmission. The interface accepts the media content created for a specific individual via the secure Internet Protocol television transmission for display on the television.

Another example method provides media content created for a specific individual. The media content created for a specific individual is sent to a media content server. The media content created for a specific individual is stored in the media content server. The media content created for a specific individual is sent via a secure Internet Protocol television transmission to a television device.

Another example is a media content server having a storage device to store media content created for a specific individual. An Internet Protocol television (IPTV) interface sends the media content created for a specific individual via a secure Internet Protocol television transmission to a television receiver.

Another example is a television set top box to view media content generated by a first subscriber for a second subscriber, the first and second subscribers belonging to a group of subscribers associated with a broadband network offering Internet Protocol television broadcast programming exclusively to the group of subscribers. The set top box has an interface associated with the second subscriber to the broadband network coupled to the broadband network and to a television. The interface exclusively accept transmission of media content generated by the first subscriber for the second subscriber via an Internet Protocol television transmission. The interface to accepts Internet Protocol television broadcast programming transmitted via an Internet Protocol television broadcast from the broadband network to the group of subscribers. A user control is in communication with the interface and sends a request via the interface to a media server to select a first Internet Protocol television channel to view the media content generated by the first subscriber for the second subscriber on the television and selects a second Internet Protocol television channel to view the Internet Protocol television broadcast programming on the television.

Another example system distributes media content created for a specific individual. A broadband network has multiple subscribers, the broadband network allows each of the multiple subscribers exclusive access to streaming broadcast programming transmitted over the broadband network via an Internet Protocol television (IPTV) broadcast. An upload device is in communication with the broadband network and sends media content created for a specific individual from a first subscriber to the broadband network. A media content server is coupled to the broadband network and stores the media content created for a specific individual and makes available the media content created for a specific individual exclusively to subscribers of the broadband network. The server includes an IPTV interface to send the media content created for a specific individual over the broadband network via an Internet Protocol television transmission to a second subscriber. A television device associated with the second subscriber is coupled to the broadband network to accept the media content created for a specific individual. The television device displays the media content created for a specific individual to the second subscriber

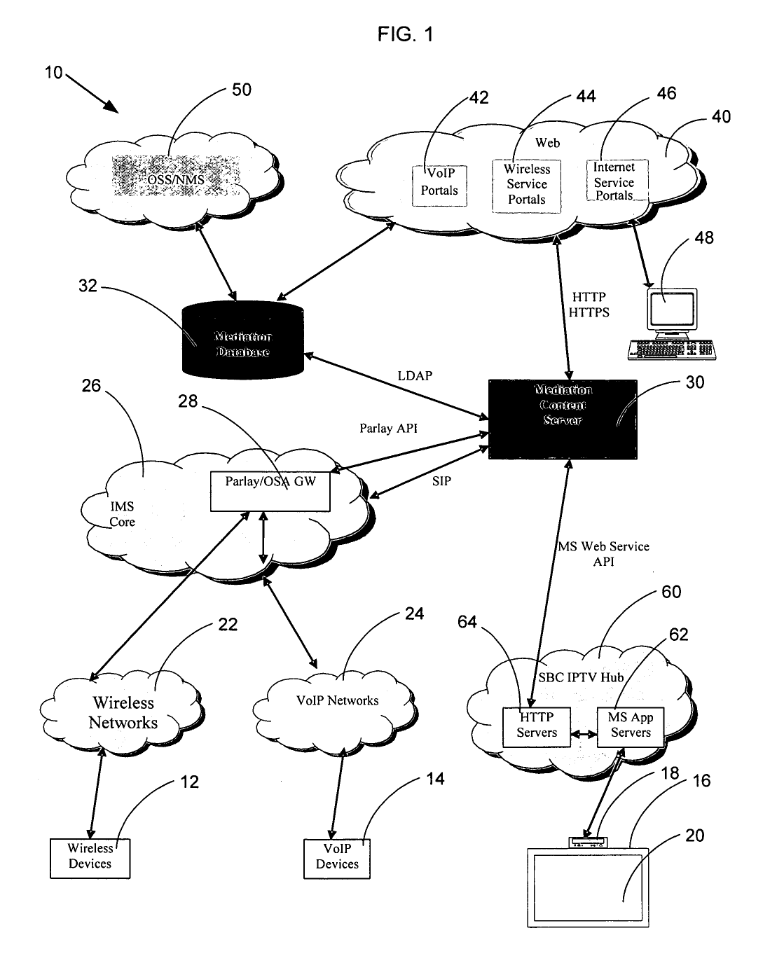

FIG. 1 is a block diagram of an example broadband service network system 10. The broadband service network system 10 allows for the service and operation of multiple devices 12, 14 and 16 belonging to a user or multiple users. In this example, the device 12 is a wireless device such as a cell phone or personal digital assistant (PDA). The device 14 in this example is a Voice over Internet Protocol (VoIP) device such as a sound card or other hardware used in conjunction with a personal computer, a USB phone or a Bluetooth wireless phone. The device 16 is an Internet Protocol Television (IPTV) device such as a set top box (STB) decoder 18 and a television 20. It is to be understood by those of ordinary skill in the art that each device 12, 14 and 16 may represent multiple devices each used by many other users.

The wireless device 12 receives and sends signals to a wireless network 22, while the VoIP device 14 sends and receives IP signals with an IP network such as a VoIP network 24. In this example, both the wireless network 22 and the VoIP network 24 are coupled to an IP multi-media subsystem (IMS) core 26. The IMS is an open, standardized, operator friendly, Next Generation Networking (NGN) multi-media architecture for mobile and fixed IP services. The IMS in this example is a VoIP implementation based on a third generation partnership project (3GPP) variant of session initiation protocol (SIP), and runs over the standard Internet protocol (IP). It may be used by telecommunications operators in NGN networks which combine voice and data in a single packet switched network, to offer network controlled multi-media services. The IMS core 26 is designed to provide Internet services for all subscribers or customers of the IMS core 26 on different devices such as the devices 12 and 14 in FIG. 1. The example IMS core 26 uses open standard IP protocols allowing the merger of the Internet with cellular systems, using cellular technologies to provide ubiquitous access and Internet technologies to provide other services. Of course those of ordinary skill in the art will understand that different networks other than the IMS architecture may be used for the IMS core 26.

In this example, the IMS core 26 has an Application Programming Interface (API), which is an open service access (OSA)/gateway (GW) 28 providing an interface for different programs exchanging data. For example the OSA/GW 28 can support telephone protocols (e.g., Parlay) or a multimedia communication protocol (e.g., session initiation protocol (SIP)). Those of ordinary skill in the art will appreciate that different cores may be used for the wireless network 22 and the VoIP network 24.

The IMS core 26 is in communication with a mediation content server 30 using an API that allows use of a telephone protocol and a multimedia communication protocol such as SIP. The mediation content server 30 is coupled via an information access protocol (e.g., the lightweight directory access protocol (LDAP)) to a mediation database server 32. The mediation database server 32 stores identification and account information used by the mediation content server 30 to send data to the devices 12, 14 and 16.

The mediation content server 30 is coupled via web communication protocols such as hypertext transfer protocol (http) and/or hypertext transfer protocol security (https) to the world wide web 40. The mediation content server 30 may draw subscriber instructions from various portals such as a VoIP service provider portal 42, a wireless service provider portal 44 and an Internet content provider portal 46. Of course, other portals may be provided that allow subscribers to reset their options for the various services. Different subscribers may access the portals 42, 44 and 46 via web browser devices such as a personal computer 48. Of course other web browser capable devices such as cell phones, PDAs, etc. may be used to access the portals 42, 44 and 46.

The mediation database server 32 also communicates with portals such as portals 42, 44 and 46 to send and receive subscriber information to and from the portals. The mediation database server 32 communicates with an operation support systems (OSS) and business support systems (BSS) network 50 to support functions such as billing, network management, repairs and servicing. In this example, the support system 50 is the SBC Lightspeed network, but other network management systems may be used for supporting Internet based multi-media services.

The IPTV device 16 is coupled to receive content via a secure Internet Protocol television service from an IPTV hub or branch office 60. The IPTV hub 60 includes an Internet Protocol Television application server 62 (e.g. Microsoft IPTV edition software), which processes content and interfaces with IPTV devices such as the IPTV set top box 18. On the example of FIG. 1, the IPTV application server 62 is coupled to a video service platform 64. The video service platform 64 is coupled to the mediation content server 30 to receive programming content via Internet Protocol packets in a secure Internet Protocol television broadcast for transmission to the IPTV device 16. As those of ordinary skill in the art will appreciate, there can be multiple IPTV hubs similar to the IPTV hub 60 each of which serve a number of IPTV subscribers. In this example, the broadband network 10 offers exclusive Internet Protocol television broadcast programming to its subscribers.

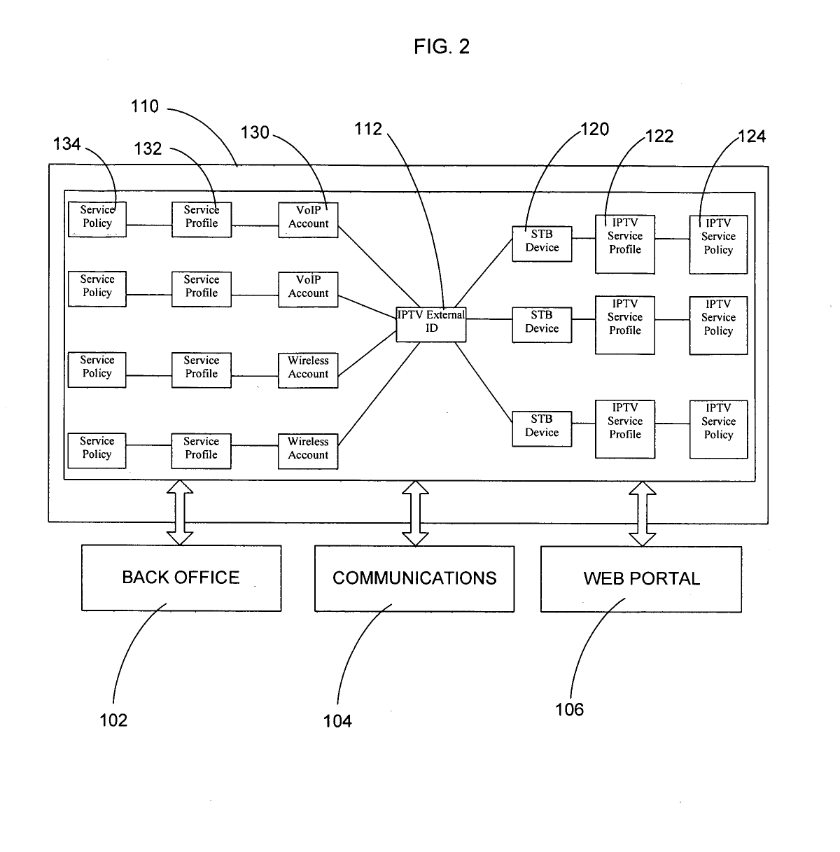

FIG. 2 is a block diagram of the data schema design for entries in the mediation database server 32 that store data for subscriber accounts and phone numbers for the subscribers who own devices using the wireless service network 22 and the VoIP network 24, and accounts and IPTV STB device data for IPTV subscribers using IPTV devices such as IPTV device 16 in FIG. 1. These subscribers may access the information in these accounts via web portals such as the portals 42, 44 and/or 46 from the web 40. In this example, the same service provider provides the networks 22 and 24 and IPTV services in order to offer subscribers a range of services, but the services may be offered by different providers. The mediation database server 32 has database interfaces for runtime access from other applications. Example database interfaces in the database server 32 include a back office interface 102, a communications interface 104, and a web portal interface 106. Those of ordinary skill in the art will appreciate that different languages may be supported by the database server 32 including, for example, LDAP, SQL with JDBC or ODBC, JAVA and XML.

The back office interface 102 allows communication with other operational support systems (OSS), business support system (BSS) and network management systems (NMS) components for back office functions such as ordering, activation, and accounting etc. The communications interface 104 allows communication with applications in the mediation content server 30 as will be explained below. The communications interface 104 is used for subscriber information look up during provision of content to specific subscribers by the mediation content server 30. A web portal interface 106 is coupled to the web 40 in FIG. 1 and to various web portals such as portals 42, 44 and 46 to enable subscriber access to service information and control of the service via the portals. This may include for example an interface with the VoIP portal 44, an interface with wireless service provider portal 42, and an interface with the Internet service portal 46. The web portal interface 106 via a portal allows a subscriber to enable/disable or fine tune service features and policies for a subscribers' respective service or services associated with a particular subscriber account.

In the illustrated example, IPTV subscribers such as the user of the IPTV device 16 are assigned an identification code. For example, certain IPTV subscribers can create and use an external IPTV subscriber ID in a form similar to normal email address. Since subscribers may send customized media content to receivers of other types of media, the mediation database 32 identifies an IPTV subscriber by utilizing a familiar identification framework such as a telephone number.

FIG. 2 shows the main data components and schema within the mediation database server 32 which are stored in a database 110. The database 110 is accessible via the interfaces 102, 104 and 106 explained above. The database 110 stores accounts such as an account 112 which is identified by the IPTV subscriber ID in this example. Each account such as account 112 may be connected to zero or more IPTV STB device accounts 120. The IPTV STB device accounts 120 each have a service profile data file 122 and each service profile data file 122 has an associated service policy data file 124. Each set top device account 120 includes identification for a particular STB as well as the subscriber associated with the STB. Each account such as account 112 may be connected with zero or more VoIP accounts (phone numbers) 130. The VoIP accounts 130 each have a service profile data file 132 and each service profile data file 132 has an associated service policy data file 134. Each account such as account 112 may be connected with zero or more wireless accounts (mobile phone numbers) 140. The wireless accounts 140 each have a service profile data file 142 and each service profile data file 142 has an associated service policy data file 144. Other accounts for other communications or media services may also be stored in the database 110 for association with subscriber accounts such as the account 112.

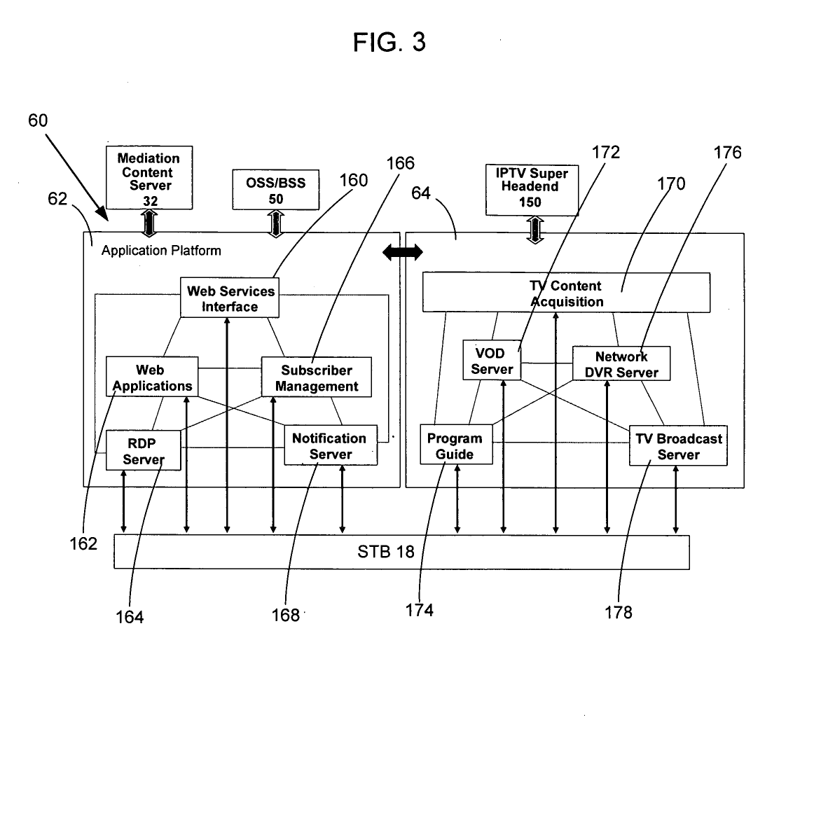

FIG. 3 is a block diagram of the example branch office or hub 60 in FIG. 1. The hub 60 communicates with set top boxes such as the set top box 18 in FIG. 1 which provides an interface to provide media content on a television such as the television 20. The hub 60 supports video content such as broadcast television programming or video on demand. The hub 60 provides different applications to support the IPTV services on the STBs. As explained above, the hub 60 is connected to the support network 50 and the content server 30 in FIG. 1. The hub 60 is also coupled to an IPTV super headend 150 which supplies broadcast programming content.

The application server 62 of the hub 60 includes various applications which interface with the STB 18. The applications include a web services interface 160, a web applications server 162, a remote desktop protocol (RDP) server 164, a subscriber management system 166 and a notification server 168. The web services interface 160 and the web applications server 162 provide the subscriber with various web services. The RDP server 164 interfaces with an RDP client on the STB 18 to provide an IPTV viewer control over various viewing functions. The subscriber management system 166 performs various management functions, such as authorization, accounting and authentication. The subscriber management system 166 also manages the various subscriber services such as video on demand and channel access to the subscriber. The notification server 168 provides notices to the subscriber and STB 18 regarding the system operation.

The video service platform 64 includes a TV content acquisition system 170, a video on demand server 172, an electronic program guide system 174, a network digital video recorder server 176, and a TV broadcast server 178. The TV content acquisition system 170 acquires television broadcast programming from sources such as an optical network or satellite transmissions via the IPTV super headend 150. The video on demand server 172 provides video on demand content and is connected to a video on demand content aggregator which is located off site and stores video content for delivery to a requesting acquisition system such as the content acquisition system 170.

Channel information and program guides are provided by the electronic program guide system 174 to provide programming and content information. Additional actions may be scheduled via the digital video recorder (DVR) server 176 which provides control over digital recording if such a feature is supported by the STB 18. All broadcasts to the STB 18 are managed by the TV broadcast server 178.

An OSS/BSS gateway 184 provides the interface to the support network 50 in FIG. 1. The subscriber management system 166 is a front end for accounting information for billing and tracking purposes supported by the support network 50. The notification system 168 is used to receive and send notifications to the set top box 18 of program requests and programs.

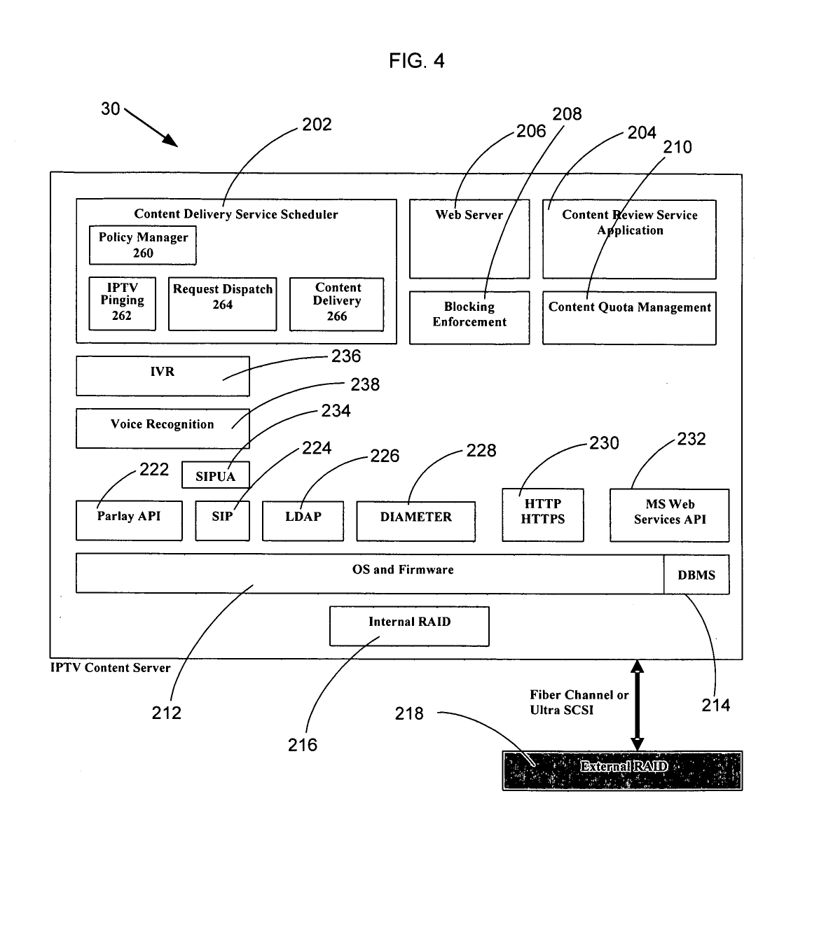

FIG. 4 is a block diagram of the system architecture of the mediation content server 30 in FIG. 1. The architecture may be implemented on any standard server platform that satisfies system requirements on manageability, security, reliability and performance. As shown in FIG. 1, the content server 30 is coupled to the mediation database server 32. Several methods and call flows are defined to allow subscribers to send various types of customized media content to IPTV subscribers from multiple sources such as web browser devices or from mobile devices for storage in the database server 30 for uni-broadcast or transmission over IPTV devices such as the device 16 in FIG. 1.

The mediation content server 30 in the illustrated example is supported by an IMS SIP application server in the IMS Network core 26. The SIP Application Server in this example includes an SIP Interface (termed an ISC Reference Point in the 3GPP IMS standard). Those of ordinary skill in the art will appreciate that a telephone system (e.g., Parlay) application server may be used to support the mediation content server 30 instead. If a telephone system server is used, a set of APIs (e.g., Parlay OSA API) communicate with a telephone gateway device (e.g., a Parlay OSA Gateway) that, in turn, communicates with the IMS network via an ISC Reference Point. With the SIP application server implementation, the mediation content server 30 plays the role of a SIP termination user agent in terms of 3GPP IMS standard. In the case of a telephone system server implementation, the mediation content server 30 sits behind an appropriate SIP Capability Service Function inside the Parlay OSA gateway (SCF). Together, the application and the gateway play a role of a SIP termination user agent.

In the illustrated example, the mediation content server 30 includes a content delivery service scheduler 202, a content review service application 204, a web server 206, a blocking enforcement application 208 and a content quota management application 210 which all generally regulate the receipt, storage and transmission of media content provided by individuals which will be explained below. The content server 30 further includes general operating system software and firmware 212 including a database management module 214. The content and other relevant data is stored in an internal redundant array of independent disks (RAID) 216 coupled via a high capacity storage interface such as an Ultra-SCSI interface and/or in an external RAID 218 accessible via a fiber channel 220 and controlled by an external controller. Those of ordinary skill in the art will appreciate that any storage device with high capability may be used for the RAID devices 216 and 218. The content server 30 includes various interfaces including a telephone system API 222 (e.g. Parlay), an SIP interface 224, an information interface (e.g. LDAP) 226, an authentication, authorization and accounting (AAA) interface 228 (e.g., using the DIAMETER protocol), a hypertext protocol interface 230, and a web services interface 232.

The SIP interface 224 interfaces with the IMS based VoIP network system 24 in FIG. 1 via an SIP user agent 234 which acts as a call state engine. The telephonic system API 222 in this example uses the telephone system API 222 to interact with OSA/Parlay Gateway, which in term uses Customized Applications for Mobile networks Enhanced Logic (CAMEL) to interface with the wireless network 26 in FIG. 1. As will be explained, under a service partnership agreement, any subscribers who have accesses to the telecommunication networks 22 and 24 can dial a special number that represents the mediation content server 30 to access the content services provided by the mediation content server. In order to support such capability, the content server 30 includes an interactive voice recognition application 236 and voice recognition application 238.

The mediation content server 30 runs the web service application interface 232 that is designed for IPTV. In this example, the web service application interface 232 is based on Microsoft Web Service based API specifications which include MS Notification Service API, HTTP/HTTPS provided by Microsoft. The mediation content server 30 implements the Web server 206 within the system to allow content upload and download via various interfaces described below. The Web server 206 also has accesses to AAA function via the AAA interface 228 that can authenticate subscribers and authorize services. The Web server 206 also has access to the mediation database server 32 via various interfaces, such as information interface 226 or the database management module 214 to resolve the subscriber information received and stored. The web server 206 is supported with a reliable and adequately sized storage such as the RAID 216 and/or RAID 218.

To extend the IPTV service for those subscribers or customers with VoIP or wireless accounts, dial plan, translation table and routing numbers are provisioned on the IMS core 26 in FIG. 1 allowing the IMS core to perform digit analysis, recognize the incoming call, and route the incoming call to the mediation content server 30. The mediation content server 30 is assigned by a standard IMS Public Service Identity (PSI) and the translation rules in IMS SIP feature server includes a provisioning of mapping of the designated call number (8xx or a 3-digit number) to the IMS PSI identifying the “IPTV Content Service AS” that represents the mediation content server 30 to telephony users. In this way, a telephony user can upload individual content to the mediation content server 30, which can deliver the content to a recipient IPTV STB such as the STB 18 in FIG. 1.

The mediation content server 30 stores media content created for a specific individual such as another subscriber which are sent to IPTV devices such as the IPTV device 16 in FIG. 1 via a high speed Internet connection (in this example, IPTV) when requested by the subscriber. The individualized accounts from the database server 32 associated with the media content allow the content server 30 to regulate the media content sent to each IPTV device via the blocking enforcement application 208.

A subscriber can create individualized media content and upload the individualized media content to the mediation content server 30 via an upload device such as a personal computer for transmission to other subscribers having an IPTV device. A task schedule is stored by the content server 30 in order to deliver stored media content prepared by individuals. The individualized media content is stored in the mediation content server 30 and the task schedule is updated by the service scheduler 202. The content service scheduler 202 will send the individualized media content to designated IPTV subscribers as appropriate.

Individualized media content may be provided to the content server 30 from any number of upload devices. For example, a subscriber may create individualized media content via a personal computer such as the computer 48 and upload that content via the web 40 in FIG. 1. The computer 48 opens an access to a web server coupled to the web 40 that has a connection to the mediation content server 30 in FIG. 1. A URL link to the IPTV Content Service Portal can be published in other partnering service portals, such as the VoIP service portal 42, the wireless service portal 44, the Internet content provider portal 46, etc. In this manner, a subscriber can log into his own account using https on a web browser device such as the personal computer 48 and create media content and configure send rules (send-to subscriber, send time, expiration time, etc.) associated with the media content via a web application supplied by the portal. The web server 206 in the content server 30 in FIG. 4 interfaces with the web portals to accept content.

Another example is to create media content by an individual for storage on the content server 30 from wireless devices such as wireless device 12 in FIG. 1 via wireless Internet access. The wireless devices to create media content may include a cellular phone with a digital camera to produce a digital picture or video clip. The web server 206 has a front end that provides adaptation of presentations to the smaller screens on wireless devices. The content server 30 deploys a similar web front end for wireless Internet accesses for subscribers to create individualized media content and send the content to the content server 30.

Another example is to create content in the IPTV content server 30 is from wireless devices and VoIP phones such as VoIP device 14 in FIG. 1 via the telephony networks 24. The SIP interface 224 and the telephone system API 222 are provided on the content server 30 to serve this application. A subscriber can dial a designated number to reach the content server 30. After a call session is set up, the calling party can interact with the content server 30 using the IVR system 236 and the voice recognition application 238 to create content and order the content to be sent.

The IPTV content server 30 supports a broad range of media content created for a specific individual which may include individualized media content creations supplied by individual subscribers. For example, the content server 30 may have some popular multi-media content provided to subscribers for selection and order, such as music, video clip, slide shows and electronic creating cards. The content server 30 may have a subset of the aforementioned multimedia content that can be mixed with customizations provided by the subscribers. For example, personal messages may be added to the electronic greeting cards. Some video clips can be joined by a subscriber's own images and/or clips in a play list. A slide show can be combined with other photos. The content server 30 may further support individual creation of media content from scratch. One example would be for a subscriber taking some digital pictures from a wireless device such as a cell phone with a camera and upload the photos to the content server 30 and order to send the photos to specified IPTV receivers associated with other subscribers.

After content is created and a send order is issued by the subscribers to distribute the individualized media content to certain other subscribers and/or all subscribers, the content server 30 stores the content in high capacity storage media such as the internal RAID array 216 or the external RAID array 218. The internal file system for the content server 30 is updated with the storage location (directory and file name, etc.) for the newly stored media content. Alternatively, the content may be stored on a local server such as the local hub 60 in FIG. 1. The content delivery service scheduler 202 is updated with a new task in its task queue and with a pointer to the individualized media content. The individualized media content is ready to be delivered to other subscribers.

The service scheduler 202 keeps track of all content service requests and requested service time (if any) from the IPTV devices which are generally initiated by subscribers. The service scheduler 202 also periodically checks on the availability of the target IPTV recipients for the content delivery stored on the mediation content server 30. The service scheduler 202 also schedules and initiates a content service task based on internal policy and factors such as system workload, service priority, target availability, and schedules requested by the content initiator for each task.

The service scheduler 202 includes a policy manager 260, an IPTV pinging manager 262, a request dispatch manager 264 and a content delivery manager 266. When the policy manager 260 is implemented, the mediation content server 30 will implement Class-of-Service (COS) based multi-queue service scheduler. The policy manager 260 works in conjunction with the content service scheduler 202 to offer subscribers with a valued added priority service. With a potentially higher billing charge, a sender can order media content to be sent with a delivery timing guarantee. The policy manager 260 constantly monitors the system workload and the connection quality with intended delivery targets (i.e., receivers) to assist the content delivery service in the server to adjust the content delivery Quality of Service (QoS) characteristics. For example, when the network is busy, the policy manager 260 may decide, based on policy, to adjust the content's resolution, pixel size, codecs, and frame rate, etc. to reduce the network resource consumption.

The review application 204 allows IPTV recipients to review the individualized media content received at an earlier time. After the media content has been received by a recipient subscriber, the mediation content server 30 can store the media content for a predefined time period. For example, a default time period to store the media content (typically for free of charge) is one week. A recipient subscriber can request to extend the time to keep the media content on the server 30 for a fee or other consideration. The kept media content after the initial viewing can be reviewed by the recipient subscriber by using a software application such as an RDP application on the RDP server 164 in FIG. 3 to display the content on an IPTV device.

The content quota management application 210 keeps a historical log of the storage of media content. The content quota management application 210 in the illustrated example employs a quota system that “assigns” a storage quota for each IPTV subscriber. When media content received by a particular IPTV subscriber hasn't exceeded the quota, the media content will be stored on the server 30 and not removed. When an IPTV subscriber's storage quota exceeds a predefined high water mark, the content quota management application 210 will initiate a “clean up” process that will find expired media content and remove it from the content server 30. A system level water mark can be implemented to enhance the system utilization by determining whether a system-wide high water mark hasn't been reached in which case some IPTV subscribers may be able to exceed the quota, which effectively reduces the available space for other subscribers. However, since not all subscribers will highly utilize this service, some system level share may be able to increase the system total utilization.

Every subscriber has an account in the mediation database server 32 which reflects the accounts belonging to that subscriber including wireless, VoIP or IPTV accounts such as the account 112 shown in FIG. 2. Minimally, a simple account may only have an external account ID in the form of something similar to an email address (such as Microsoft Passport account for hotmail, or Yahoo account for Yahoo email and instant message).

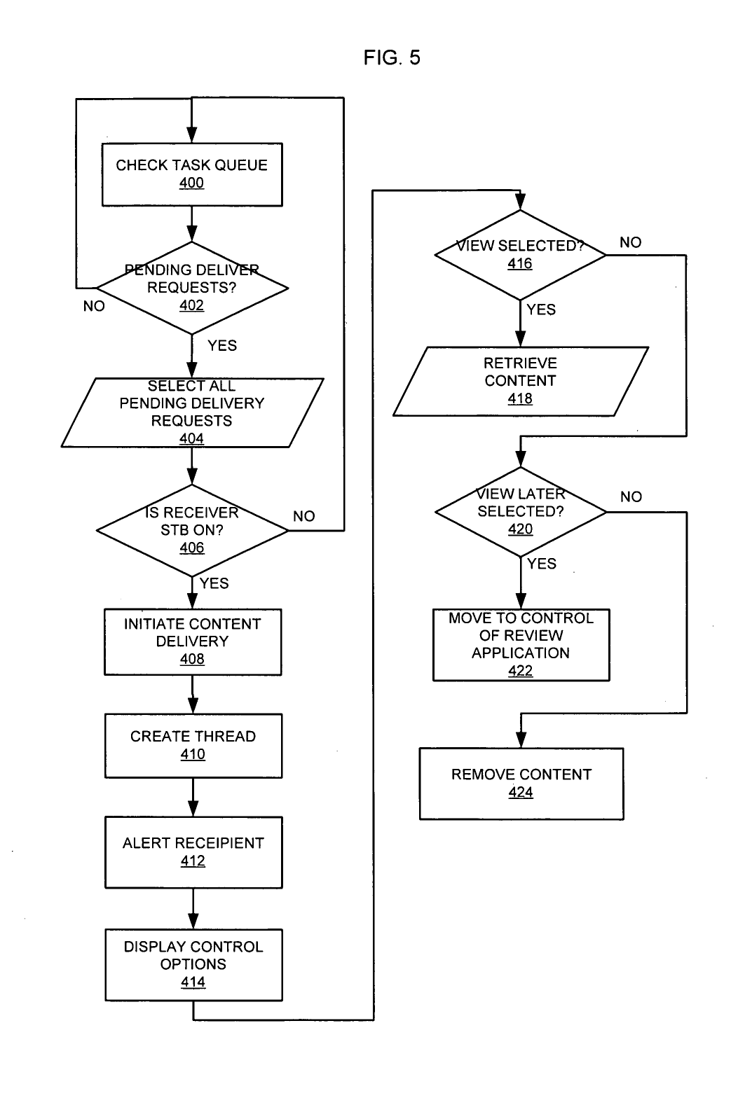

FIG. 5 is a flow diagram showing the delivery process used by the content delivery service scheduler 202 to deliver content to requester subscribers who are viewing IPTV devices. The content delivery service scheduler 202 runs two background processes, a dispatch process via the dispatch manager 264 and a ping process via the pinging manager 262. The dispatch process manager 264 periodically loops through the task queue (block 400). The scheduler 202 determines whether there are pending delivery requests in the task queue in block 402 and continues to loop through the task queue if there are no pending delivery requests. If there are pending requests, the dispatch process manager 264 selects all pending delivery requests received from subscribers (block 404). Some delivery requests may not be ready if a sender has a start time scheduled for the individualized content. The service scheduler 202 may be programmed to implement a class of service, so that the dispatch manager 264 carries out higher priority requests first.

The pinging process manager 262 uses the web service API 232 in FIG. 4 to access the subscriber management subsystem 166 in the IPTV hub 60 in FIG. 3 to discover the status of a receiver's IPTV set(s) (block 406). The pinging process manager 262 will initiate an actual content delivery when an IPTV subscriber has at least one IPTV device turned on (block 408).

If a receiving subscriber has his/her IPTV device turned on and there is a content delivery order outstanding for the subscriber, the content delivery service scheduler 202 will create an application thread to execute the content delivery (block 410). The child application thread communicates with the IPTV hub 60 in FIG. 1 to deliver the media content (block 410). The application thread will alert the recipient(s) by generating a remote desktop protocol (RDP) window via the RDP server 164 on the receiving subscriber's active IPTV screen with a notification message which specifies the sender, the send time, and a brief description of the content (block 412). The background data is taken from the information data provided by the individual submitting the media content and is stored on the content server 30. The background data is read and sent with the media content. The application thread will allow the display on the RDP notification window of three control commands, “View”, “View Later”, and “No, Thanks.” (block 414).

If a recipient clicks on “View” control (block 416) via a user control (e.g., a remote control), then the RDP client on the set top box such as the STB 18 in FIG. 1 will generate a signal to the RDP server 164 in the subsystem 62, which, in turn, will generate a retrieve request to the content server 30 to retrieve and play the content (block 418). After the initial viewing of the content, the RDP client will provide a control “Replay” to allow immediate replaying of the content. If the recipient decides to close the RDP client, then the content will be moved to under the control of the review application 204 for future review by the recipients.

If a recipient clicks on “View Later” (block 420), then the RDP client on the STB will generate a signal to the RDP server 164 which in turn, will generate a directive to the content server 30 via the subscriber management system 166 to move the content to the control of the review application 204 for future review (block 422). If a recipient clicks on “No, Thanks” (block 418), then the RDP client on the STB will generate a signal to the RDP server164, which in turn, will generate a directive via the subscriber management system 166 to the content server 30 to remove the media content (block 424).

The RDP application on the STB may have a control “Block the Sender” which allows a user to block all content sent by the same sender. The media content will be automatically put in the review application 204 in the content server 30. The content service scheduler 202 will not initiate any notification to the recipients. The RDP application may also have a control option of “Block All” which allows a user to send any content sent by any sender to be automatically put in the review application 204 without notification from the content service scheduler.

As explained above, each subscriber with an account in the mediation database 32 may be configured with a storage quota in the content server 30 for individualized media content. After initial delivery of the individualized media content to a receiver, the media content is removed from the content delivery service scheduler 202. The content is then added to the content review service application 204. The media content then is moved in the file system from the pending delivery area to a long term storage area such as the external RAID 218 in FIG. 3.

An IPTV subscriber can request to review the individualized media content in a number of ways. A subscriber may use an IPTV user control to initiate an RDP-based content review process. The RDP client on IPTV STB such as the STB 18 in FIG. 1 via the RDP server 164 in the hub 60 issues a request to retrieve a list of media content stored in the content server 30 and under the control of the content review service application 204 accessible to that subscriber. The web application system 162 in the IPTV hub 60 in FIG. 3 will execute the retrieval request via the web interface 160 to the content server 30. The web interface 160 in the IPTV hub 60 contacts the web server 206 in the IPTV content server 30 to retrieve the content list for the subscriber. The web server 206 in the IPTV content server 30 requests a content list from the content review service application 204, which provides a complete list of available content for the requesting subscriber stored on the content server 30.

The IPTV subscriber can move the cursor on the IPTV screen to select a particular content of interest. By double clicking on the item, the RDP client on the STB 18 sends a request to retrieve and replay the content to the hub 60. The request is forwarded through the same path described above to the content review service application 204, which retrieves the requested media content from the file system in storage and sends it to the hub 60 for transmission on the IPTV device 16.

A subscriber can also use a personal computer such as the personal computer 48 in FIG. 1 to access the web server 206 in the IPTV content server directly and review the content on a personal computer that has minimal multimedia capability (sounds and media players). This process path is in no difference from a normal HTTP application that allows a user to view multimedia content via the web.

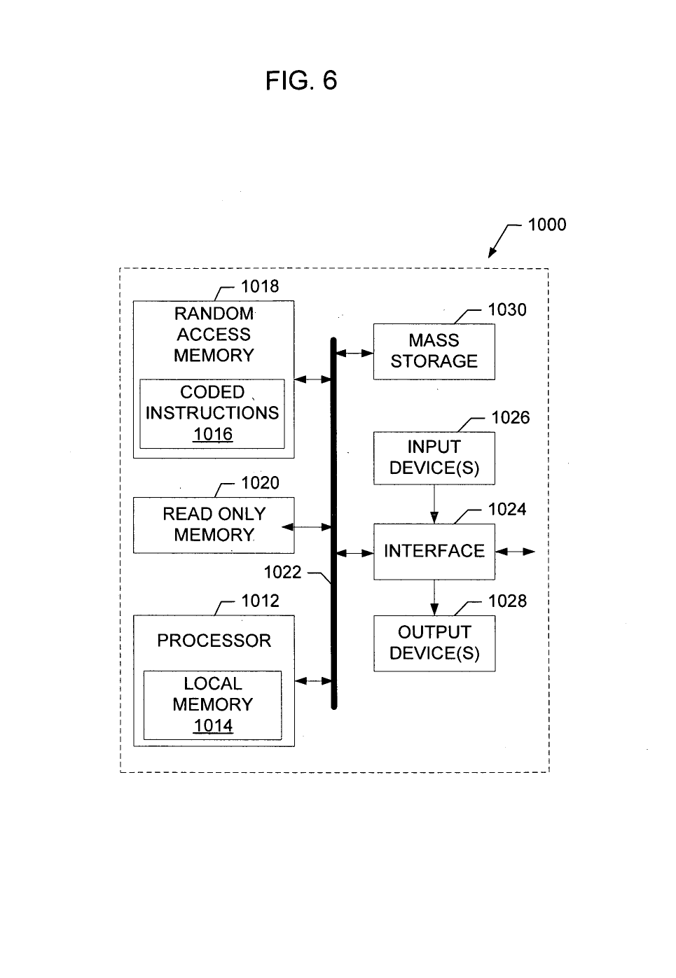

FIG. 6 is a schematic diagram of an example processor platform 1000 which may be used to execute the example machine readable instructions illustrated in FIG. 1 to create, receive and transmit the individualized media content. For example, the processor platform 1000 can be implemented by one or more general purpose microprocessors, microcontrollers, etc. The processor platform 1000 of the example includes the processor 1012 that is a general purpose programmable processor. The processor 1012 executes coded instructions present in a memory 1020 of the processor 1012. The processor 1012 may be any type of processing unit, such as a microprocessor. The processor 1012 includes a local memory 1014. The processor 1012 may execute, among other things, the example machine readable instructions illustrated of the personal computer 48 in FIG. 1.

The processor 1012 is in communication with the main memory including a read only memory (ROM) 1020 and/or a RAM 1018 via a bus 1022. The RAM 1018 may be implemented by Synchronous Dynamic Random Access Memory (SDRAM), Dynamic DRAM, and/or any other type of RAM device. The ROM 1020 may be implemented by flash memory and/or any other desired type of memory device. Access to the memory space 1020 and 1018 is typically controlled by a memory controller (not shown) in a conventional manner. The RAM 1018 may be used by the processor 1012 to implement the memory 1020, and/or to store coded instructions 1016 that can be executed to implement the example machine readable instructions illustrated in FIGS. 1-11.

The processor platform 1000 also includes a conventional interface circuit 1024. The interface circuit 1024 may be implemented by any type of well known interface standard, such as an external memory interface, serial port, general purpose input/output, etc. One or more input devices 1026 are connected to the interface circuit 1024. One or more output devices 1028 are also connected to the interface circuit 1024. Additional permanent storage may be offered via a mass storage device 1030 which may be a hard drive. In the illustrated example, a telephone or telephony equipment may be part of the input devices 1026.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general functionality. Accordingly, replacement standards and protocols having the same functions are equivalents which are contemplated by this patent and are intended to be included within the scope of the accompanying claims.

This patent contemplate examples wherein a device is associated with one or more machine readable mediums containing instructions, or receives and executes instructions from a propagated signal so that, for example, when connected to a network environment, the device can send or receive voice, video or data, and communicate over the network using the instructions. Such a device can be implemented by any electronic device that provides voice, video and/or data communication, such as a telephone, a cordless telephone, a mobile phone, a cellular telephone, a Personal Digital Assistant (PDA), a set-top box, a computer, and/or a server.

Additionally, although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A television set top box to view media content created for a specific individual, comprising:
an interface coupled to a television to display an identification of a channel on the television;
a user control in communication with the interface, the user control to allow a user to select the channel to activate a secure Internet Protocol television transmission; and
wherein the interface accepts the media content created for a specific individual via the secure Internet Protocol television transmission for display on the television.

2. The television set top box of claim 1 further comprising a transmitter coupled to the interface to transmit an identification code associated with the set top box to a media content server, the media content server storing the media content created for a specific individual; and the interface to accept media content created for a specific individual having a send request associated with the identification code.

3. The television set top box of claim 1 wherein the interface displays an indication that the media content created for a specific individual is available for viewing and wherein the user control allows a user an option to not view the media content created for a specific individual.

4. The apparatus of claim 2 wherein the interface provides a menu of media content created for a specific individual stored on the media content server available for viewing on the television.

5. The apparatus of claim 1 wherein interface displays information associated with the media content created for a specific individual.

6. The apparatus of claim 5 wherein the information associated with the media content created for a specific individual is stored on the media content server.

7. The apparatus of claim 1 wherein the media content created for a specific individual is a video clip.

8. The apparatus of claim 1 wherein the media content created for a specific individual is a digital photograph.

9. A method of providing media content created for a specific individual comprising:
sending the media content created for a specific individual to a media content server;
storing the media content created for a specific individual in the media content server; and
sending the media content created for a specific individual via a secure Internet Protocol television transmission to a television device.

10. The method of claim 9 further comprising storing identification information associated with the media content created for a specific individual in the media content server.

11. The method of claim 9 wherein the media content created for a specific individual is sent via a world wide web interface.

12. The method of claim 9 further comprising sending identification data relating to a recipient for the media content created for a specific individual to the media content server.

13. The method of claim 12 wherein the television device is associated with the identification data relating to the recipient for the media content created for a specific individual.

14. The method of claim 13 further comprising:
sending identification data relating to a second recipient for the media content created for a specific individual to the media contents server; and
sending the media content created for a specific individual via a secure Internet Protocol television transmission to a second television device associated with the identification data relating to the second recipient.

15. The method of claim 9 further comprising determining if the television device is active and sending the media content created for a specific individual when the television device is active.

16. The method of claim 9 wherein the media content created for a specific individual is a video clip.

17. The method of claim 9 wherein the media content created for a specific individual is a digital photograph.

18. A media content server, comprising:
a storage device to store media content created for a specific individual; and
an Internet Protocol television (IPTV) interface to send the media content created for a specific individual via a secure Internet Protocol television transmission to a television receiver.

19. The media content server of claim 18 wherein the storage device stores identification information associated with the media content created for a specific individual.

20. The media content server of claim 18 further comprising a content interface to accept media content created for a specific individual.

21. The media content server of claim 20 wherein the content interface is a world wide web site.

22. The media content server of claim 20 wherein the content interface accepts identification data relating to a recipient for the media content created for a specific individual.

23. The media content server of claim 22 further comprising a content delivery service scheduler to direct the IPTV interface to send the media content created for a specific individual to the television receiver, wherein the television receiver is associated with the identification data relating to the recipient.

24. The media content server of claim 23 wherein the content interface accepts identification data relating to a second recipient for the media content created for a specific individual; and wherein the content delivery service scheduler directs the IPTV interface to send the media content created for a specific individual to a second television receiver associated with the identification data relating to the second recipient.

25. The media content server of claim 23 wherein the content delivery service scheduler includes a pinging application to determine if the television receiver is active, and wherein the IPTV interface sends the media content created for a specific individual when the television receiver is active.

26. The media content server of claim 18 further comprising a content review service application to store the media content created for a specific individual, the content review service application to direct the interface to send the media content created for a specific individual after a delay period.

27. A television set top box to view media content generated by a first subscriber for a second subscriber, the first and second subscribers belonging to a group of subscribers associated with a broadband network offering Internet Protocol television broadcast programming exclusively to the group of subscribers, the set top box comprising:
an interface associated with the second subscriber to the broadband network coupled to the broadband network and to a television, the interface to exclusively accept transmission of media content generated by the first subscriber for the second subscriber via an Internet Protocol television transmission and the interface to accept Internet Protocol television broadcast programming transmitted via an Internet Protocol television broadcast from the broadband network to the group of subscribers; and
a user control in communication with the interface to send a request via the interface to a media server to select a first Internet Protocol television channel to view the media content generated by the first subscriber for the second subscriber on the television and to select a second Internet Protocol television channel to view the Internet Protocol television broadcast programming on the television.

28. A system to distribute media content created for a specific individual comprising:
a broadband network having multiple subscribers, the broadband network to allow each of the multiple subscribers exclusive access to streaming broadcast programming transmitted over the broadband network via an Internet Protocol television (IPTV) broadcast;
an upload device in communication with the broadband network, the upload device to send media content created for a specific individual from a first subscriber to the broadband network;
a media content server coupled to the broadband network to store the media content created for a specific individual and make available the media content created for a specific individual exclusively to subscribers of the broadband network, the server including an IPTV interface to send the media content created for a specific individual over the broadband network via a Internet Protocol television transmission to a second subscriber; and
a television device associated with the second subscriber coupled to the broadband network to accept the media content created for a specific individual, the television device to display the media content created for a specific individual to the second subscriber.
